(19) United States
(12) Patent Application Publication
(10) Pub. No.: US 2026/0021481 A1
(43) Pub. Date: Jan. 22, 2026

(54) Preparation and Application of Anionic Resin with High Selective Adsorption of Ergothioneine

(71) Applicant: Shenzhen Siyomicro Bio-Tech Co., Ltd., Shenzhen (CN)

(72) Inventors: Yanfeng ZHANG, Shenzhen (CN); Zhi LI, Shenzhen (CN); Tonghai GAO, Shenzhen (CN)

(21) Appl. No.: 19/339,425

(22) Filed: Sep. 25, 2025

Related U.S. Application Data
(63) Continuation of application No. PCT/CN2024/103074, filed on Jul. 2, 2024.

(30) Foreign Application Priority Data
Aug. 15, 2023 (CN) 2023110251325

(51) Int. Cl. B01J 41/13; B01D 15/36; B01J 41/07; B01J 47/02; B01J 49/53

(52) U.S. Cl. CPC B01J 41/13; B01D 15/363; B01J 41/07; B01J 47/02; B01J 49/53

(57) ABSTRACT

The disclosure provides preparation and application of an anionic resin with high selective adsorption of ergothioneine, belonging to the field of biochemical engineering. A polyamine-type epoxy weak-base anionic resin is used as a carrier for the first time. Ni atoms are loaded onto the target resin carrier in the form of [NiCl₄]²— ions, followed by in situ reduction and rinsing regeneration to prepare a metal Ni nanoparticle-loaded polyamine-type epoxy weak-base anionic resin. The preparation process is simple and the stability is good. The disclosure has strong selective adsorption for ergothioneine in fermentation broths and the facile elution. The disclosure can be widely applied in purification processes for ergothioneine preparation through fermentation and enzymatic catalysis.

### TECHNICAL FIELD

The disclosure belongs to the field of biochemical engineering, and relates to preparation and application of an anionic resin with high selective adsorption of ergothioneine.

### BACKGROUND

Ergothioneine, as a natural antioxidant, has multiple physiological functions such as free radical scavenging, detoxification, and maintenance of DNA biosynthesis, normal cell growth, and cellular immunity. Ergothioneine has wide applications in the fields such as pharmaceuticals, cosmetics, food and beverages, and biotechnology.

At present, ergothioneine on the market is mainly produced through enzymatic catalysis and biological fermentation. However, both enzymatic catalytic solutions and fermentation broths contain large amounts of impurities such as salts, miscellaneous acids, and pigments, making separation and purification challenging. In addition, ergothioneine is a structurally unique amino acid with an inner salt structure, which results in conventional general-purpose resins for amino acids failing to meet the adsorption and impurity removal requirements for ergothioneine. Conventional fillers either exhibit weak adsorption capacity with low separation efficiency or strong adsorption capacity that makes elution difficult and also results in poor separation efficiency.

In 2005, Nanjing University applied for patent ZL200510095177.5 (Method for Preparing Resin-Based Arsenic Removal Adsorbent). This patent involves immobilizing hydrated iron oxide (non-zero-valent iron) particles on the inner surface of an anion exchange resin, mainly utilizing the synergistic adsorption effect of amino groups of the resin and the hydrated iron oxide particles on arsenate to achieve deep purification of arsenate in water bodies.

In 2009, Zhang Weiming et al. applied for patent CN101474560A (Zero-Valent Iron-Loaded Nano-Composite Resin for Catalytic Degradation of Pollutants and Method for Preparing Same). This method involves introducing FeCl₄⁻ ions into the inner and outer surfaces of the resin via the ion exchange effect, reducing the Fe ions introduced into the inner and outer surfaces of the resin to nano zero-valent iron, and then washing and drying the nano zero-valent iron to obtain the zero-valent iron-loaded nano-composite resin. This resin combines the Donnan pre-enrichment effect on inorganic anionic pollutants in water bodies and the efficient catalytic degradation effect of nano zero-valent iron on environmental pollutants, and overcomes the shortcomings such as the tendency of nano zero-valent iron particles to agglomerate, chemical instability, and significant pressure head loss due to a small particle size. The resin exhibits rapid, efficient, and cost-effective catalytic degradation of trace pollutants in the environment.

In 2009, Lv Lu et al. applied for patent CN101716525A (Anionic resin-Based CdS-loaded Composite Material and Method for Preparing Same). This involves introducing CdCl₄²⁻ ions into the inner and outer surfaces of the carrier resin via the ion exchange effect, precipitating the CdCl₄²⁻ ions introduced into the inner and outer surfaces of the carrier resin into CdS using a Na₂S or (NH₄)₂S solution, and performing filtration, hydrothermal treating in a reaction kettle, washing, and drying to obtain the anionic resin-based CdS composite material. This invention solves the problem of significant loss of active ingredients in the subsequent separation and recovery processes of CdS powder, and enhances its pre-enrichment capacity for anionic pollutants in water bodies, thereby promoting photocatalytic degradation, and ultimately achieving its widespread application in practical water treatment.

In 2018, Zou Jianping et al. applied for patent CN10917419A (Method for Preparing Copper-Iron Bimetal-Loaded Chelating Resin Nanomaterial). The Fe—Cu/D407 bimetal nanomaterial prepared by the method of this invention achieves an NO₃ removal rate of up to 99% or more and an N selectivity of up to 89.7%, exhibiting extremely efficient nitrate reduction performance and high selectivity for reduction to nitrogen gas.

In 2022, Guo Jianqi et al. applied for patent CN115301297A (Silver Nanoparticle-Loaded Cation Exchange Resin, Method for Preparing Same, and Application Thereof). This invention prepares a silver nanoparticle-loaded cation exchange resin, which exhibits specific adsorption performance for biodiesel sulfides.

Therefore, there is a lack of an anionic resin for high selective adsorption of ergothioneine in the related art. None of the existing metal particle-loaded cation exchange resins can achieve high selective adsorption of ergothioneine. Thus, there is an urgent need for an anionic resin that solves the problems of relatively poor selective adsorption of ergothioneine in fermentation broths and incomplete impurity removal.

### SUMMARY

### Technical Problem

In view of the problems that existing resin fillers and other resin-based metal-loaded nanomaterials have relatively poor selective adsorption of ergothioneine in fermentation broths and the impurity removal is incomplete, the disclosure aims to provide an anionic resin-based nano Ni-loaded composite material and a method for preparing the same. Not only can the problem that the existing materials have poor adsorption on ergothioneine in fermentation broths be solved, but also high selective adsorption and efficient elution of ergothioneine are realized. Therefore, accurate purification of an ergothioneine fermentation system is achieved.

### Technical Scheme

In the disclosure, according to the structural characteristics of imidazole contained in ergothioneine molecules and the structural properties of histidine, those skilled believe that ergothioneine molecules should also have strong affinity adsorption capacity for metal atoms Ni, Cu, Zn, etc. In combination with polyamine-type epoxy weak-base anionic resin materials with certain adsorption capacity for ergothioneine screened in the early stage, those skilled in the art develop a metal Ni nanoparticle-loaded polyamine-type epoxy weak-base anionic resin and a method for preparing the same. The method of the disclosure prepares the metal Ni nanoparticle-loaded polyamine-type epoxy weak-base anionic resin material for the first time.

This material has the characteristics of high selective adsorption of ergothioneine, which can effectively remove miscellaneous salts, pigments, miscellaneous amines, and fermentation substrates in a fermentation system. With other impurity removal means, high-purity ergothioneine with purity greater than 99.5% can be finally prepared.

The disclosure aims to prepare a metal Ni nanoparticle-loaded polyamine-type epoxy weak-base anionic resin with high selective adsorption of ergothioneine, and this resin is used for purifying ergothioneine fermentation broths.

In order to achieve the above purpose, the disclosure provides a method for preparing a metal Ni nanoparticle-loaded polyamine-type epoxy weak-base anionic resin with high selective adsorption of ergothioneine, including the following steps:
step (1) resin pretreatment: loading a resin into a chromatography column, adding an aqueous hydrochloric acid solution at a flow rate of 1 BV/h to 5 BV/h for acid washing, then rinsing with water to remove residual hydrochloric acid until the pH of effluent is 6 to 7, subsequently, adding an aqueous sodium hydroxide solution at the same flow rate, then rinsing with water again to remove residual sodium hydroxide until the pH of effluent is 7 to 8, taking the resin out, and removing surface moisture by suction filtration to obtain a regenerated resin;
step (2) adsorption of nickel ions onto the resin: preparing an aqueous nickel ion solution, adding the regenerated resin in step (1) to the aqueous nickel ion solution, shaking at room temperature for 10 min to 100 min, then performing suction filtration on the resin, and rinsing the resin with water to remove a residual solvent on a surface to obtain a treated resin; and

step (3) reduction of nickel ions on the resin: preparing an aqueous ethanol solution; then adding NaBH₄ to the prepared aqueous ethanol solution to prepare an NaBH₄ aqueous ethanol solution; finally, adding the treated resin in (2) to the NaBH₄ aqueous ethanol solution, stirring for 0.5 h to 5 h, filtering the resin, and rinsing with water to obtain the metal Ni nanoparticle-loaded polyamine-type epoxy weak-base anionic resin.

Further, in step (1), the resin is a polyamine-type epoxy weak-base anionic resin.

Further, the polyamine-type epoxy weak-base anionic resin is in the form of milky white or light yellow opaque spherical particles, in a free amine form. The polyamine-type epoxy weak-base anionic resin has the following chemical performance indicators: a total exchange capacity of ≥9.0 mmol/g, a volumetric exchange capacity of ≥1.5 mmol/mL, and a water content of 60% to 70%. The polyamine-type epoxy weak-base anionic resin is suitable for use in environments with a pH range of 1 to 9.

Further, in step (1), the resin includes Type 330 epoxy weak-base anionic resin, Type 331 epoxy weak-base anionic resin, and Type 335 epoxy weak-base anionic resin.

Further, in step (1), the aqueous hydrochloric acid solution has a concentration of 1 wt % to 10 wt %.

Further, in step (1), a volume ratio of the aqueous hydrochloric acid solution to the resin is (2 to 10):1.

Preferably, in step (1), a volume ratio of the aqueous hydrochloric acid solution to the resin is (1 to 3):1.

Further, in step (1), the aqueous sodium hydroxide solution has a concentration of 1 wt % to 10 wt %.

Further, in step (1), a volume ratio of the aqueous sodium hydroxide solution to the resin is (2 to 10):1.

Preferably, in step (1), a volume ratio of the aqueous sodium hydroxide solution to the resin is (2 to 4):1.

Further, in step (2), nickel salts in the aqueous nickel ion solution include K₂NiCl₄, K₂Ni(CN)₄, Na₂NiCl₄, and Na₂Ni(CN)₄.

Further, in step (2), the nickel salts in the aqueous nickel ion solution have a concentration of 0.1 mol/L to 1 mol/L.

Preferably, in step (2), the nickel salts in the aqueous nickel ion solution have a concentration of 0.4 mol/L to 0.8 mol/L.

Further, in step (2), a volume ratio of the aqueous nickel ion solution to the resin is (2 to 10):1.

Preferably, in step (2), a volume ratio of the aqueous nickel ion solution to the resin is (3 to 5):1.

Further, in step (2), a volume ratio of the water used for rinsing away a residual solvent on the surface to the resin is (0.5 to 2):1.

Further, in step (2), the shaking time is 10 min to 100 min.

Further, in steps (1) and (2), the processing temperature is 10° C. to 40° C.

Further, in step (3), N₂ is used for sparging to remove dissolved oxygen in a solution in both the entire solvent preparation process and the reaction process.

Further, in step (3), the aqueous ethanol solution has a volume fraction of 10% to 90%.

Preferably, in step (3), the aqueous ethanol solution has a volume fraction of 60%.

Further, in step (3), NaBH₄ in the NaBH₄ aqueous ethanol solution has a mass fraction of 1% to 50%.

Preferably, in step (3), NaBH₄ in the NaBH₄ aqueous ethanol solution has a mass fraction of 20%.

Further, in step (3), a volume ratio of the NaBH₄ aqueous ethanol solution to the resin is (0.5 to 3):1.

Further, in step (3), the stirring time is 0.5 h to 5 h.

Further, in step (3), a volume ratio of the water used for rinsing to the resin is (0.5 to 2):1.

The disclosure prepares the metal Ni nanoparticle-loaded polyamine-type epoxy weak-base anionic resin with high selective adsorption of ergothioneine according to the above method.

The disclosure provides application of the above metal Ni nanoparticle-loaded polyamine-type epoxy weak-base anionic resin with high selective adsorption of ergothioneine in the field of adsorption purification.

The disclosure provides a method for preparing a metal Ni nanoparticle-loaded polyamine-type epoxy weak-base anionic resin with high selective adsorption of ergothioneine, including the following steps:
step (1) resin pretreatment: loading a resin into a chromatography column, adding a 1 wt % to 10 wt % aqueous hydrochloric acid solution which is 2 to 10 times the volume of the resin at a flow rate of 1 BV/h to 5 BV/h, then rinsing with water to remove residual hydrochloric acid until the pH of effluent is 6 to 7, subsequently, adding a 1 wt % to 10 wt % aqueous sodium hydroxide solution which is 2 to 10 times the volume of the resin at the same flow rate, then rinsing with water again to remove residual sodium hydroxide until the pH of effluent is 7 to 8, taking the resin out, and removing surface moisture by suction filtration to obtain a regenerated resin;
step (2) adsorption of nickel ions onto the resin: preparing a 0.1 mol/L to 1 mol/L aqueous nickel ion solution, adding the regenerated resin in step (1) to the aqueous nickel ion solution with a solution volume of 2 to 10 times the resin volume, shaking for 10 min to 100 min, then filtering the resin, and rinsing the resin with water to remove a residual solvent on a surface to obtain a treated resin; and
step (3) reduction of nickel ions on the resin: preparing an aqueous ethanol solution with a volume fraction of 10% to 90%, then adding NaBH₄ to the prepared aqueous ethanol solution to prepare an NaBH₄ aqueous ethanol solution with a mass concentration of 1% to 50%, finally, adding the treated resin in (2) to the NaBH₄ aqueous ethanol solution, stirring for 0.5 h to 5 h, filtering the resin, and rinsing with water to obtain the metal Ni nanoparticle-loaded polyamine-type epoxy weak-base anionic resin.

Further, in step (1), the resin includes Type 330 epoxy weak-base anionic resin, Type 331 epoxy weak-base anionic resin, and Type 335 epoxy weak-base anionic resin.

Further, in step (2), nickel salts in the aqueous nickel ion solution include K₂NiCl₄, K₂Ni(CN)₄, Na₂NiCl₄, and Na₂Ni(CN)₄.

Further, in steps (1) and (2), the processing temperature is 10° C. to 40° C.

Further, in step (3), N₂ is used for sparging to remove dissolved oxygen in a solution in both the entire solvent preparation process and the reaction process.

Further, in step (3), after the nickel ions on the resin are reduced, the resin needs to be rinsed with deionized water, and the volume of the water used is 2 to 10 times the volume of the resin.

The disclosure provides a purification method through high selective adsorption of ergothioneine in a fermentation broth, including the following steps:
step (1) ceramic membrane sterilization: the fermentation broth is subjected to microfiltration sterilization through a ceramic membrane to obtain a clarified fermentation broth;
step (2) nanofiltration, concentration, and desalination: concentrating the clarified fermentation broth in step (1) with a nanofiltration membrane, and collecting a concentrated solution to obtain a nanofiltered fermentation broth;
step (3) column chromatography adsorption for impurity removal: first, loading the above prepared metal Ni nanoparticle-loaded polyamine-type epoxy weak-base anionic resin with high selective adsorption of ergothioneine into a resin column, then enabling a nanofiltered and concentrated fermentation broth to flow through the resin column at a flow rate of 0.1 BV/h to 2 BV/h, and after loading is completed, rinsing the column with water to remove residual waste liquid until the conductivity is <0.1 mS/cm;
step (4) elution: eluting the ergothioneine adsorbed on the resin column with an aqueous imidazole solution at a flow rate of 0.1 BV/h to 2 BV/h, and then collecting eluate;
step (5) macroporous resin adsorption for impurity removal: adsorbing imidazole in the eluate collected in step (4) by using a macroporous resin, and collecting effluent;
step (6) concentration and crystallization: concentrating the feed liquid collected in step (5); and
step (7) centrifugation and drying: centrifuging the concentrated material liquid in step (6), rinsing a solid obtained after centrifugation with an aqueous ethanol solution, and then drying the solid to obtain pure ergothioneine.

Further, in step (1), the ceramic membrane has a pore size of 50 nm to 200 nm.

Further, in step (1), a membrane filtration temperature for the ceramic membrane is 35° C. to 45° C., and a transmembrane pressure is 0.03 MPa to 0.05 MPa.

Further, in step (1), the ergothioneine content in the fermentation broth is 5 g/L to 8 g/L.

Further, in step (2), the nanofiltration membrane has a molecular weight cut-off of 100 Daltons to 600 Daltons.

Further, in step (2), a membrane filtration temperature for the nanofiltration membrane is 30° C. to 40° C., and a transmembrane pressure is 0.1 MPa to 0.15 MPa.

Further, in step (2), in the nanofiltration process, when a flux is reduced by half, water replenishment is initiated to control the flux and maintain the flux at a level half of the original flux or more.

Further, in step (2), the conductivity at a membrane filtration end of the nanofiltration membrane is <1.2 ms/cm to 1.5 ms/cm.

Further, in step (3), a volume ratio of the nanofiltered fermentation broth to the metal Ni nanoparticle-loaded polyamine-type epoxy weak-base anionic resin is 20: (0.5 to 3).

Further, in step (4), the imidazole in the eluent imidazole aqueous solution has a concentration of 1% to 40% (v/v).

Further, in step (5), the macroporous resin used is any one of a polar macroporous resin, a medium-polar macroporous resin, or a weak-polar macroporous resin.

Further, in step (5), the eluent has an elution flow rate of 0.1 BV/h to 2 BV/h.

Further, in step (6), the concentration temperature is 40° C. to 80° C., and the vacuum degree is −0.1 MPa to −0.08 MPa.

Further, in step (7), the aqueous ethanol solution has a concentration of 70% to 90% (v/v).

Further, in step (7), the drying temperature is 40° C. to 80° C., the vacuum degree is −0.1 MPa to −0.08 MPa, and the drying time is 2 h to 12 h.

The disclosure provides ergothioneine obtained by the above purification method.

The disclosure provides application of the above purification method in the field of ergothioneine purification.

### Beneficial Effects

The disclosure solves the problems including inefficient impurity removal, incomplete impurity removal, and high investment cost encountered in the preparation of high-quality ergothioneine through enzymatic catalysis and fermentation. The metal Ni nanoparticle-loaded polyamine-type epoxy weak-base anionic resin prepared by the disclosure enables strong selective adsorption and high selective elution of ergothioneine without requiring too complex equipment or processes, thereby facilitating the refining and purification of the ergothioneine fermentation broth.

### BRIEF DESCRIPTION OF FIGURES

FIG. 1 shows crystal morphology of a purified ergothioneine product prepared in Example 2 (imaged by an electron microscope).

FIG. 2 shows the appearance of the purified ergothioneine product prepared in Example 2.

FIG. 3 is a liquid chromatogram of the purified ergothioneine product prepared in Example 2.

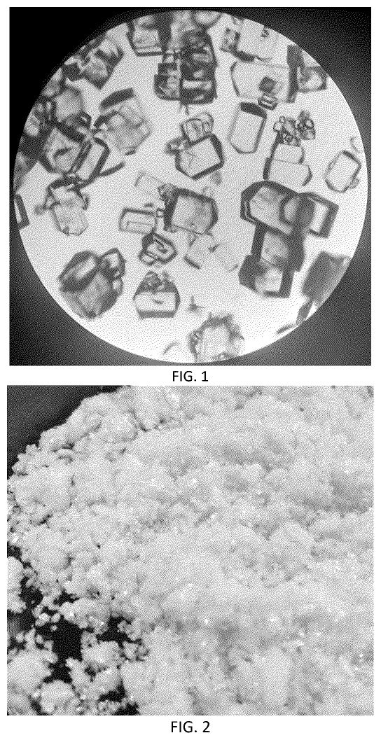

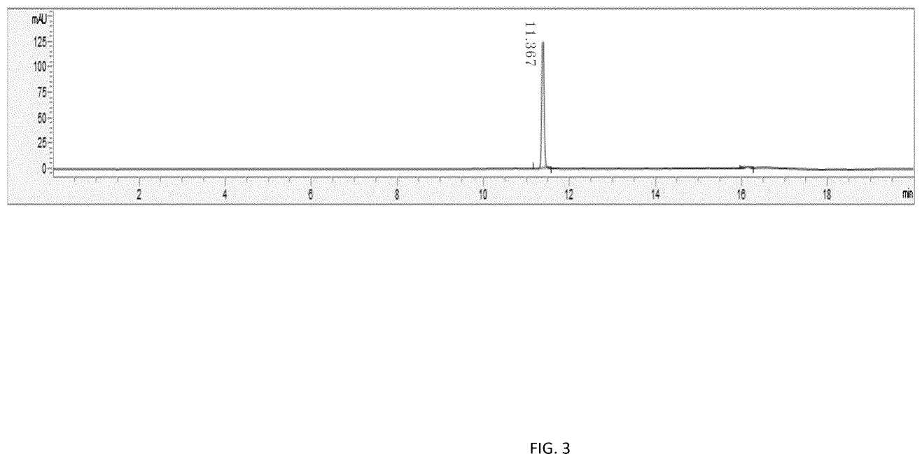

### DETAILED DESCRIPTION

### Raw Material Source

Strain information and fermentation conditions involved in the disclosure are all derived from the patent CN114854659A Method for Producing Ergothioneine and Application Thereof. Fermentation broths are prepared according to fermentation conditions of Example 5 in the patent CN114854659A. Resins used in the disclosure are all sourced from Sunresin New Materials Co., Ltd., Xi'an.

### Detection Method

For the detection method of ergothioneine, reference is made to Construction and Optimization of Ergothioneine-producing Escherichia Coli (2022).

HPLC detection of ergothioneine: An Agilent 1200 high-performance liquid chromatography (HPLC) system with a UV detector and a C18 column (Agilent ZORBAX Eclipse Plus, 250 mm×4.6 mm, 5 μm) is adopted. The mobile phase is water and methanol in a ratio of 99:1, and the flow rate is 0.7 mL/min. The column temperature is 30° C. The detection wavelength is 257 nm. An injection volume is 5 μL. The run time is 20 min.

Ergothioneine standards with concentrations of 5 mg/L, 25 mg/L, 50 mg/L, 100 mg/L, 200 mg/L, and 500 mg/L are prepared respectively. By using the above HPLC detection method, a standard curve is plotted with a concentration of an ergothioneine standard as the horizontal ordinate and a peak area as the vertical coordinate. The linear equation of the standard curve is y=35.484x-49.415, with R²=1.0.

### Example 1

This example involved the preparation of a metal Ni nanoparticle-loaded polyamine-type epoxy weak-base anionic resin. In step (3), N₂ was used for sparging to remove dissolved oxygen in a solution in both a solvent preparation process and a reaction process.
(1) Resin regeneration: 1 L of a 330 resin (polyamine-type epoxy weak-base anionic resin) was taken and loaded into a chromatography column. The resin was subjected to acid washing by using 2 L of a 4 wt % aqueous hydrochloric acid solution at a flow rate of 1 BV/h. Then the resin was rinsed with pure water to remove residual hydrochloric acid. The elution was performed until the pH of effluent was 7. Subsequently, 3 L of a 4 wt % aqueous sodium hydroxide solution was added by pumping at the same flow rate (1 BV/h). Then the resin column was rinsed with pure water again to remove residual sodium hydroxide. The elution was performed until the pH of effluent was 7.5. The resin was taken out, and surface moisture was removed by suction filtration to obtain a regenerated resin.
(2) Adsorption of Ni ions: 4 L of a 0.6 mol/L K₂NiCl₄ aqueous solution was first prepared. 1 L of the regenerated resin was added to the K₂NiCl₄ aqueous solution. A container was placed in a shaker, and was shaken at room temperature for 60 min. Then the resin was subjected to suction filtration, and rinsed with 1 L of pure water to remove a residual solvent on the surface for later use, thereby obtaining a treated resin.
(3) Reduction of Ni ions on the resin: A 60% (v/v) aqueous ethanol solution was first prepared. Then a fixed amount of NaBH₄ was added to the prepared aqueous ethanol solution to prepare a 20% (mass fraction) NaBH₄ aqueous ethanol solution. Finally, the treated resin in step (2) was added to the NaBH₄ aqueous ethanol solution (the volume of the reduction solution was about 2 times the volume of the resin). Mechanical stirring was performed for reaction for 2 h. The resin was filtered, and rinsed with 1 L of pure water to obtain the metal Ni nanoparticle-loaded polyamine-type epoxy weak-base anionic resin.

### Example 2

This example involved purification through high-selective adsorption of ergothioneine in a fermentation broth by using the metal Ni nanoparticle-loaded polyamine-type epoxy weak-base anionic resin.

Fermentation strain information and fermentation conditions were all derived from the patent CN114854659A Method for Producing Ergothioneine and Application Thereof. Fermentation was first performed according to fermentation conditions of Example 5 in the patent CN114854659A, to obtain 20 L of a 6.8 g/L ergothioneine fermentation broth. The fermentation broth was then purified according to the following steps.
(1) Ceramic membrane sterilization: The fermentation broth was subjected to microfiltration sterilization through a 50 nm ceramic membrane at 40° C. and a pressure of 0.05 Mpa to obtain a clarified fermentation broth.
(2) Nanofiltration, concentration, and desalination: The clarified fermentation broth obtained in step (1) was concentrated and desalinated with a nanofiltration membrane with a molecular weight cut-off of 200 Daltons at 35° C. and a pressure of 0.15 MPa. As the nanofiltration was progressed, the flux was gradually decreased. When the flux was reduced by half, pure water replenishment was initiated to maintain the flux at a level half of the original flux or more. Nanofiltration was stopped when the conductivity reached 1.2 mS/cm, to obtain a nanofiltered fermentation broth.
(3) Column chromatography adsorption for impurity removal: First, 1 L of the metal Ni nanoparticle-loaded polyamine-type epoxy weak-base anionic resin prepared in Example 1 was loaded into a resin column. Then a nanofiltered and concentrated fermentation broth was enabled to flow through the resin column at a flow rate of 1 BV/h. After loading is completed, the column was rinsed with a small amount of pure water to remove residual waste liquid until the conductivity was <0.1 mS/cm.
(4) Elution: The ergothioneine adsorbed on the resin column was eluted with a 10% (v/v) aqueous imidazole solution at a flow rate of 0.8 BV/h. Then whether the elution was completed was monitored by liquid chromatography analysis. Elution was stopped when a liquid chromatogram showed that the concentration of the ergothioneine is <0.1 g/L. All imidazole-containing eluate was collected.
(5) Macroporous resin adsorption for impurity removal: 2 L of a medium-polar macroporous resin was taken and loaded into a resin column. The collected imidazole-containing eluate was enabled to flow through the resin column at a flow rate of 0.8 BV/h. The column was rinsed with a small amount of pure water for residual ergothioneine, and the effluent was collected.
(6) Concentration and crystallization: The collected effluent was concentrated under reduced pressure at 60° C. and a vacuum degree of −0.1 MPa. When the concentration of the ergothioneine in the material liquid was >150 g/L, concentration was stopped. The effluent was cooled to induce crystallization. After cooling to 4° C. and performing of heat preservation for 1 h, centrifuging was performed.
(7) Centrifugation and drying: The crystallized ergothioneine was centrifuged by using a centrifuge. During centrifugation, a filter cake was rinsed with an 80% aqueous ethanol solution for 30 s. Then drying under reduced pressure was performed at 60° C. and a vacuum degree of −0.1 MPa for 10 h to obtained 109.5 g of purified ergothioneine product (yield: 82.5%) with a purity of 99.73% (as detected by HPLC).

### Comparative Example 1

In the case that the metal Ni nanoparticle-loaded polyamine-type epoxy weak-base anionic resin in step (3) of Example 2 was replaced with other unmodified common resins, and all other operations and conditions remained unchanged, the ergothioneine fermentation broth was purified according to the method in Example 2. The purity and yield of the obtained ergothioneine are shown in Table 1 below.

TABLE 1

| | | Ergothi- | Ergothi- | |
|---|---|---|---|---|
| Experiment | Resin | oneine | oneine | |
| No. | name | yield % | purity % | Note |
| 1 | 732 | 36.4 | 98.2 | Common strong-acid |
| | | | | cationic resin |
| 2 | D110 | 31.9 | 96.5 | Common weak-acid |
| | | | | cationic resin |
| 3 | D201 | 20.8 | 82.5 | Common strong-base |
| | | | | anionic resin |
| 4 | D301 | 25.8 | 84.5 | Common weak-base |
| | | | | anionic resin |
| 5 | 330 | 58.9 | 89.6 | Raw resin in the |
| | | | | disclosure |
| 6 | Example 1 | 81.2 | 99.75 | Nano resin prepared |
| | resin | | | by the disclosure |
| Blank | No resin | / | / | Crystallization |
| | | | | impossible |

Due to the high selective adsorption of ergothioneine by the prepared metal Ni nanoparticle-loaded polyamine-type epoxy weak-base anionic resin, it can be seen that the metal Ni nanoparticle-loaded polyamine-type epoxy weak-base anionic resin demonstrates significantly superior ergothioneine yield and purity after purification compared with other unmodified resins. Furthermore, even among resins unmodified with metal nanoparticles, the raw resin selected by the disclosure, e.g., Type 330 polyamine epoxy weak-base anionic resin, exhibits a significantly higher yield than other common resins, indicating that its structure has strong affinity for ergothioneine.

### Comparative Example 2

The loaded metal element in step (2) of Example 1 was replaced with other metal elements to prepare polyamine-type epoxy weak-base anionic resins loaded with different types of nano metal. In the case that the resin in step (3) of Example 2 was replaced with the prepared different types of nano metal resins, and all other operations and conditions remained unchanged, the ergothioneine fermentation broth was purified according to the conditions in Example 2. The purity and yield of the obtained ergothioneine are shown in Table 2 below.

TABLE 2

| | | | Ergothi- | Ergothi- |
|---|---|---|---|---|
| Experiment | Nano | Nano metal | oneine | oneine |
| No. | metal | raw material | yield % | purity % |
| 1 | Ag | KAgCl₂ | 72.5 | 99.77 |
| 2 | Zn | K₂ZnCl₄ | 56.5 | 97.6 |
| 3 | Fe | K₂FeO₄ | 59.5 | 96.8 |
| 4 | Mg | K₂MgCl₄ | 68.2 | 98.98 |
| 5 | Cu | K₂CuCl₄ | 65.2 | 99.62 |
| 6 | Ni | K₂NiCl₄ | 81.5 | 99.74 |
| Blank | Non-nanomodified | / | 58.1 | 88.95 |
| | resin | | | |

It can be seen that although the nanomodified resin significantly improves the purification yield and purity of ergothioneine, 330 resin modified with nano Ni shows the highest purification yield compared with 330 resin modified with other metal nanoparticles or unmodified 330 resin, while the purity is very high.

### Comparative Example 3

In the case that the concentration of K₂NiCl₄ in step (2) of Example 1 was optimized so as to prepare K₂NiCl₄ aqueous solutions with concentrations of 0.2 mol/L, 0.4 mol/L, 0.6 mol/L, 0.8 mol/L, and 1.0 mol/L, respectively, and all other conditions remained unchanged, the ergothioneine fermentation broth was purified according to the conditions in Example 2. The purity and yield of the obtained ergothioneine are shown in Table 3 below.

TABLE 3

| | | Ergothi- | Ergothi- |
|---|---|---|---|
| Experiment | Concentration of K₂NiCl₄ | oneine | oneine |
| No. | mol/L | yield % | purity % |
| 1 | 0.2 | 72.4 | 98.67 |
| 2 | 0.4 | 81.3 | 99.62 |
| 3 | 0.6 | 82.5 | 99.73 |
| 4 | 0.8 | 82.8 | 99.78 |
| 5 | 1.0 | 82.1 | 99.65 |

It can be seen that as the concentration of K₂NiCl₄ is increased, the effectiveness of the prepared resin is improved. When the concentration is increased to 0.6 mol/L, the performance of the resin tends to be stable. Therefore, considering both economic and yield factors, the optimal concentration for preparing the resin with K₂NiCl₄ is 0.6 mol/L.

What is claimed is:

1. A method for preparing a metal Ni nanoparticle-loaded polyamine-type epoxy weak-base anionic resin with high selective adsorption of ergothioneine, comprising the following steps:
step (1) resin pretreatment: loading a resin into a chromatography column, adding an aqueous hydrochloric acid solution at a flow rate of 1 BV/h to 5 BV/h for acid washing, then rinsing with water to remove residual hydrochloric acid until the pH of effluent is 6 to 7, subsequently, adding an aqueous sodium hydroxide solution at the same flow rate, then rinsing with water again to remove residual sodium hydroxide until the pH of effluent is 7 to 8, taking the resin out, and removing surface moisture by suction filtration to obtain a regenerated resin;
step (2) adsorption of nickel ions onto the resin: preparing an aqueous nickel ion solution, adding the regenerated resin in step (1) to the aqueous nickel ion solution, shaking at room temperature for 10 to 100 minutes, then performing suction filtration on the resin, and rinsing the resin with water to remove a residual solvent on a surface to obtain a treated resin; and
step (3) reduction of nickel ions on the resin: preparing an aqueous ethanol solution, then adding NaBH₄ to the prepared aqueous ethanol solution to prepare an NaBH₄ aqueous ethanol solution, finally, adding the treated resin in (2) to the NaBH₄ aqueous ethanol solution, stirring for 0.5 to 5 hours, filtering the resin, and rinsing with water to obtain the metal Ni nanoparticle-loaded polyamine-type epoxy weak-base anionic resin.

2. The method according to claim 1, wherein in step (2), nickel salts in the aqueous nickel ion solution comprise K₂NiCl₄, K₂Ni(CN)₄, Na₂NiCl₄, and Na₂Ni(CN)₄; and the prepared aqueous nickel ion solution has a concentration of 0.1 mol/L to 1 mol/L.

3. The method according to claim 1, wherein in step (3), NaBH₄ in the NaBH₄ aqueous ethanol solution has a mass fraction of 1% to 50%; and a volume ratio of the NaBH₄ aqueous ethanol solution to the resin is (0.5 to 3):1.

4. A metal Ni nanoparticle-loaded polyamine-type epoxy weak-base anionic resin with high selective adsorption of ergothioneine prepared by the method according to claim 1.
